(19) United States
(12) Patent Application Publication
(10) Pub. No.: US 2025/0058420 A1
(43) Pub. Date: Feb. 20, 2025

(54) MACHINING DEFECT ANALYSIS DEVICE, MACHINING SYSTEM, MACHINING DEFECT ANALYSIS METHOD, AND MACHINING METHOD

(71) Applicant: Mitsubishi Electric Corporation, Tokyo (JP)

(72) Inventors: Go SATO, Tokyo (JP); Hiroki KANEKO, Tokyo (JP)

(73) Assignee: Mitsubishi Electric Corporation, Tokyo (JP)

(21) Appl. No.: 18/725,908

(22) PCT Filed: Jan. 6, 2022
(86) PCT No.: PCT/JP2022/000267

§ 371 Date: Jul. 1, 2024

(51) Int. Cl. B23Q 17/20

(52) U.S. Cl. CPC B23Q 17/20

(57) ABSTRACT

A machining defect analysis device includes: a cutting point information acquisition unit that acquires cutting point information indicating a position of a cutting point that is a point at which a tool attached to a machine tool cuts a workpiece, the cutting point corresponding to each of a plurality of tip points included in a tool trajectory that is information indicating a movement path of the tip point of the tool; a feature acquisition unit that acquires a feature indicating a characteristic of machining, the feature being calculated corresponding to each of the plurality of tip points; and a machining defect analysis unit that identifies, based on the cutting point information and the feature, a machining defect region in which a machining defect of the workpiece occurs and a cause of the machining defect in the machining defect region.

### FIELD

The present disclosure relates to a machining defect analysis device, a machining system, a machining defect analysis method, and a machining method for analyzing a machining defect that occurs in machining of a workpiece with a machine tool.

### BACKGROUND

A machine tool drives an actuator such as a motor to move a workpiece or a tool, thereby machining the workpiece with the tool into a desired shape. At this time, a machining program describing a movement command that specifies a tool path is used. The machining program is input to a numerical control device that controls the machine tool, and the numerical control device analyzes the machining program and creates a command position of a drive shaft by interpolating the tool path obtained from the movement command for each predetermined control cycle. The numerical control device performs drive control of the actuator while precisely managing the position of the drive shaft based on the command position.

However, the machined workpiece has a machining error with respect to the machining target shape due to various causes. The machining error leads to a machining defect such as a failure in satisfying the dimensional accuracy or a flaw on the machined surface. In this case, rework such as design review and reprocessing occurs, which reduces the production efficiency.

Patent Literature 1 discloses a technique of computing the actual feed speed of a drive shaft of a machine tool, converting the actual feed speed into an image, and determining whether machining is good or bad through machine learning using image data. By using the technique disclosed in Patent Literature 1, it is possible to automatically determine whether a machining defect occurs.

### CITATION LIST

### Patent Literature

Patent Literature 1: Japanese Patent Application Laid-open No. 2021-068225

### SUMMARY OF INVENTION

### Problem to be Solved by the Invention

However, according to the technique disclosed in Patent Literature 1, although it is possible to determine whether a machining defect occurs due to the actual feed speed, there is a problem that labor for the analysis work of identifying which part of the workpiece has the machining defect and identifying the cause of the machining defect is large.

The present disclosure has been made in view of the above, and an object thereof is to obtain a machining defect analysis device capable of reducing the worker's labor for the analysis work of identifying the cause of a machining defect.

### Means to Solve the Problem

In order to solve the above-described problems and achieve the object, a machining defect analysis device according to the present disclosure includes: a cutting point information acquisition unit to acquire cutting point information indicating a position of a cutting point that is a point at which a tool attached to a machine tool cuts a workpiece, the cutting point corresponding to each of a plurality of tip points included in a tool trajectory that is information indicating a movement path of the tip point of the tool; a feature acquisition unit to acquire a feature indicating a characteristic of machining, the feature being calculated corresponding to each of the plurality of tip points; and a machining defect analysis unit to identify, based on the cutting point information and the feature, a machining defect region in which a machining defect of the workpiece occurs and a cause of the machining defect in the machining defect region.

### Effects of the Invention

The present disclosure can achieve the effect of reducing the worker's labor for the analysis work of identifying the cause of a machining defect.

### BRIEF DESCRIPTION OF DRAWINGS

FIG. 1 is a diagram illustrating a functional configuration of a machining defect analysis device according to the first embodiment.

FIG. 2 is a diagram illustrating an example of a tool that is based on the tool information stored in the tool information storage unit illustrated in FIG. 1.

FIG. 3 is a perspective view illustrating an example of a machining target shape stored in the machining target shape storage unit illustrated in FIG. 1.

FIG. 4 is a side view of the machining target shape illustrated in FIG. 3.

FIG. 5 is a top view of the machining target shape illustrated in FIG. 3.

FIG. 6 is a perspective view illustrating an example of a tool trajectory generated by the tool trajectory calculation unit illustrated in FIG. 1.

FIG. 7 is a top view illustrating an example of the tool trajectory generated by the tool trajectory calculation unit illustrated in FIG. 1.

FIG. 8 is a diagram for explaining the arrangement of the tool and the machining curved surface.

FIG. 9 is a diagram for explaining the relationship between the tip point of the tool and the cutting point.

FIG. 10 is a diagram for explaining the cutting point of the tool which is away from the machining curved surface.

FIG. 11 is a diagram for explaining the cutting point of the tool which interferes with the machining curved surface.

FIG. 12 is a diagram illustrating cutting points calculated corresponding to the tip points illustrated in FIG. 8.

FIG. 13 is a first diagram for explaining a method of obtaining the tip point adjacent to an arbitrary tip point included in the tool trajectory.

FIG. 14 is a second diagram for explaining a method of obtaining the tip point adjacent to an arbitrary tip point included in the tool trajectory.

FIG. 15 is a third diagram for explaining a method of obtaining the tip point adjacent to an arbitrary tip point included in the tool trajectory.

FIG. 16 is a perspective view illustrating an example of a display screen displayed by the machining defect analysis device illustrated in FIG. 1.

FIG. 17 is a top view illustrating an example of a display screen displayed by the machining defect analysis device illustrated in FIG. 1.

FIG. 18 is a diagram illustrating an example of a screen on which the display result in which the machining curved surface of the machining target shape is displayed in the display color indicating the feature and the display result in which each of the machining defect regions is displayed using the expression method that is different depending on each of the cause of the machining defect are displayed in an overlapping manner.

FIG. 19 is a flowchart for explaining the operation of the machining defect analysis device illustrated in FIG. 1.

FIG. 20 is a diagram illustrating an exemplary configuration of a computer system that implements the machining defect analysis device according to the first embodiment.

FIG. 21 is a diagram illustrating a functional configuration of a modification of the first embodiment.

FIG. 22 is a diagram illustrating a functional configuration of a machining defect analysis device according to the second embodiment.

FIG. 23 is a diagram illustrating an exemplary configuration of the model construction unit that uses machine learning. 25

FIG. 24 is a flowchart related to learning processing performed by the machining defect analysis device illustrated in FIG. 22.

FIG. 25 is a diagram illustrating a functional configuration of an inference device included in the machining defect analysis unit illustrated in FIG. 22.

FIG. 26 is a flowchart for explaining the operation of the inference device illustrated in FIG. 25.

FIG. 27 is a diagram illustrating a functional configuration of a machining defect analysis device according to the third embodiment.

FIG. 28 is a diagram schematically illustrating an example of a neural network used by the model construction unit illustrated in FIG. 27.

### DESCRIPTION OF EMBODIMENTS

Hereinafter, a machining defect analysis device, a machining system, a machining defect analysis method, and a machining method according to embodiments of the present disclosure will be described in detail with reference to the drawings.

### First Embodiment

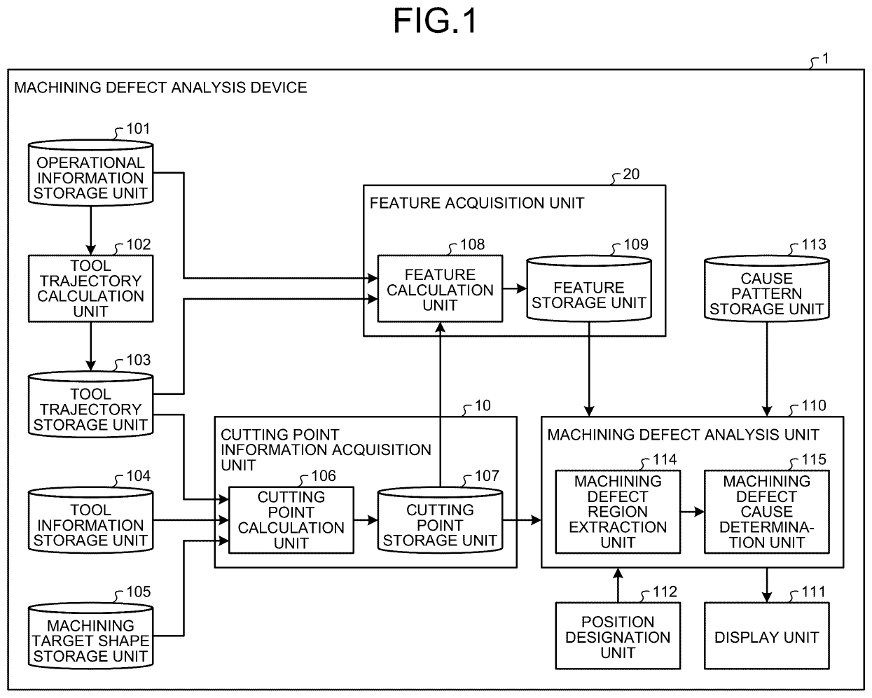

FIG. 1 is a diagram illustrating a functional configuration of a machining defect analysis device 1 according to the first embodiment. The machining defect analysis device 1 includes an operational information storage unit 101, a tool trajectory calculation unit 102, a tool trajectory storage unit 103, a tool information storage unit 104, a machining target shape storage unit 105, a cutting point information acquisition unit 10 including a cutting point calculation unit 106 and a cutting point storage unit 107, a feature acquisition unit 20 including a feature calculation unit 108 and a feature storage unit 109, a machining defect analysis unit 110, a display unit 111, a position designation unit 112, and a cause pattern storage unit 113. The machining defect analysis unit 110 includes a machining defect region extraction unit 114 and a machining defect cause determination unit 115.

The machining defect analysis device 1 has a function of supporting the analysis work of identifying a region having a machining defect which occurs in machining performed by a machine tool under the control of a numerical control device, and the cause of the machining defect.

First, an example of data that is used by the machining defect analysis device 1 will be described with reference to the drawings.

The operational information storage unit 101 stores operational information, which is information indicating the operational status of the machine tool in which the machine tool is operated. The operational information includes information obtained from the machine tool, the numerical control device that controls the machine tool, a sensor attached to the machine tool, or the like. More specifically, the operational information can include, for example, position data of each of a plurality of drive shafts included in the machine tool, the load and current value of the spindle of the machine tool, the internal temperature of the machine tool, the machining program and machining conditions that are used for operation of the machine tool, and state data such as parameters of the numerical control device. The position data, the load of the spindle, current value, and the internal temperature of the machine tool are time-series data synchronized by time. The position data of the drive shaft is information generated by the numerical control device, and includes at least one of a command position in every predetermined control cycle with respect to each of the plurality of drive shafts of the machine tool or a detected position detected in every control cycle from the position detector of each of the plurality of drive shafts. The operational information may be information acquired by actually operating the machine tool, or may be information generated by simulating the operations of the numerical control device and the machine tool through simulation or the like.

The tool information storage unit 104 stores tool information that is information defining the shape of a tool for machining a workpiece. The tool information includes information from which a tool shape can be generated, for example, information such as tool type, tool diameter, and tool length. In the case of a rotary tool such as an end mill, the tool information may include the tool central axis and the outer contour of the tool. In the case of an asymmetric shape such as a turning tool, the tool information may include parameter information.

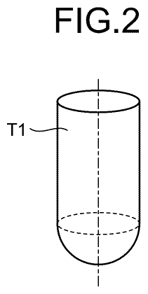

FIG. 2 is a diagram illustrating an example of a tool T1 that is based on the tool information stored in the tool information storage unit 104 illustrated in FIG. 1. The tool T1 illustrated in FIG. 2 is a ball end mill which is an end mill having a spherical tip.

The machining target shape storage unit 105 stores shape information indicating a machining target shape, which is target shape of the workpiece. The machining target shape includes a machining curved surface, which is curved surface to be machined with the tool T1.

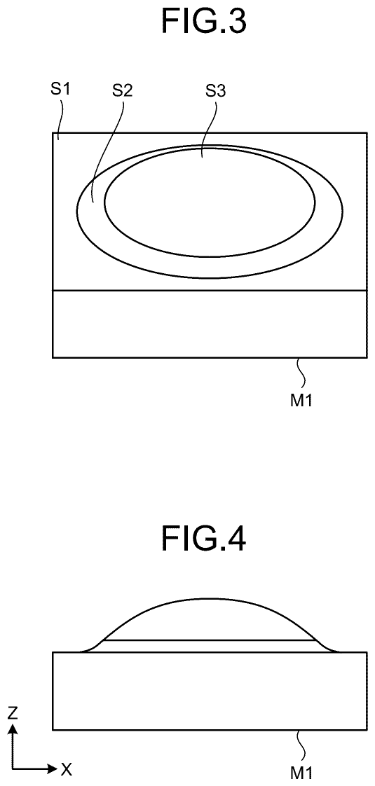

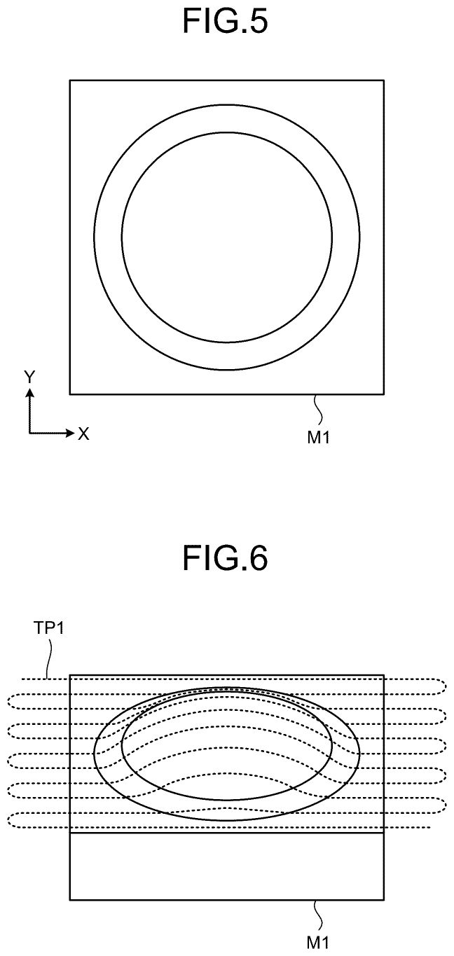

FIG. 3 is a perspective view illustrating an example of a machining target shape M1 stored in the machining target shape storage unit 105 illustrated in FIG. 1. FIG. 4 is a side view of the machining target shape M1 illustrated in FIG. 3. FIG. 5 is a top view of the machining target shape M1 illustrated in FIG. 3. The machining target shape M1 includes machining curved surfaces S1 to S3. The machining curved surfaces S1 to S3 may be simply referred to as the machining curved surface S when it is not necessary to distinguish therebetween.

The operational information, tool information, and shape information described above are acquired from the outside of the machining defect analysis device 1. The operational information, the tool information, and the machining target shape M1 may be read from the information stored in a storage medium outside the machining defect analysis device 1, may be acquired via a communication path, or may be information input by a worker using an input means such as a keyboard. The shape information may be information generated by performing data conversion from CAD data, or may be information generated by a worker inputting a figure through keyboard operation.

The tool trajectory calculation unit 102 generates a tool trajectory, which is trajectory of the tip point of the tool, based on the operational information stored in the operational information storage unit 101, and stores the generated tool trajectory in the tool trajectory storage unit 103. Here, the tool trajectory calculation unit 102 performs coordinate transformation on the position data of the time-series data included in the operational information to obtain the position of the tip point of the tool and the tool direction at the position. The position data may be a command position or a detected position. Which position data is to be used may be determined in advance or may be selected by the worker. Here, the tool trajectory calculation unit 102 performs coordinate transformation of the position data using the relative relationship between information included in the parameters of the numerical control device, such as the configuration of the drive shaft of the machine tool, the tool length, and the coordinate system, and the coordinate system of the machining target shape M1. As to the relative relationship between the coordinate system included in the parameters of the numerical control device and the coordinate system of the machining target shape M1, for example, an offset amount may be stored in advance or may be designated by a worker. The position of the tip point obtained in this manner is associated with each piece of time-series data and also stored as a tool trajectory.

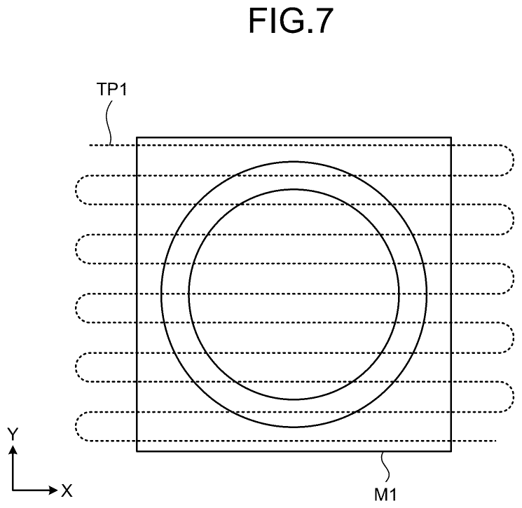

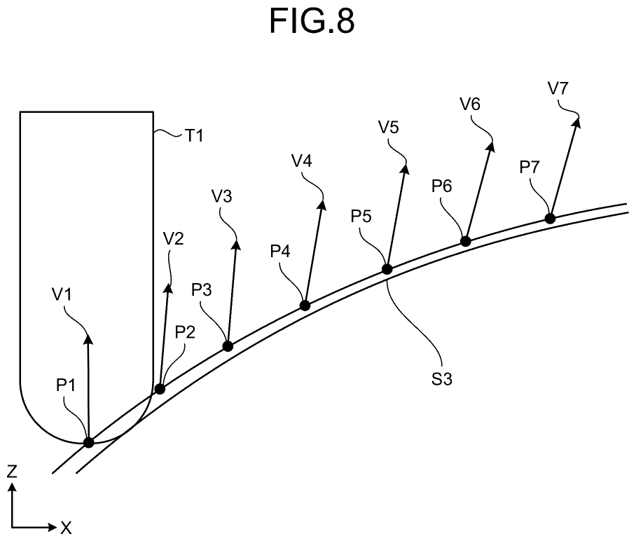

FIG. 6 is a perspective view illustrating an example of a tool trajectory TP1 generated by the tool trajectory calculation unit 102 illustrated in FIG. 1. FIG. 7 is a top view illustrating an example of the tool trajectory TP1 generated by the tool trajectory calculation unit 102 illustrated in FIG. 1. FIGS. 6 and 7 illustrate the tool trajectory TP1 and the machining target shape M1. FIG. 8 is a diagram for explaining the arrangement of the tool T1 and the machining curved surface S. FIG. 8 illustrates the positions of tip points P1 to P7 included in the tool trajectory TP1 and tool directions V1 to V7 in which the tool is located at the tip points P1 to P7, respectively. FIG. 8 is a cross-section illustrating how the tool T1 passes on the machining curved surface S3 of the machining target shape M1. At this time, the arrangement relationship between the tool T1 and the machining curved surface S3 is determined according to the positions of the tip points P1 to P7 and the tool directions V1 to V7 at the positions. Hereinafter, the tip points P1 to P7 may be simply referred to as the tip point P when it is not necessary to distinguish therebetween, and the tool directions V1 to V7 may be simply referred to as the tool direction V when it is not necessary to distinguish therebetween.

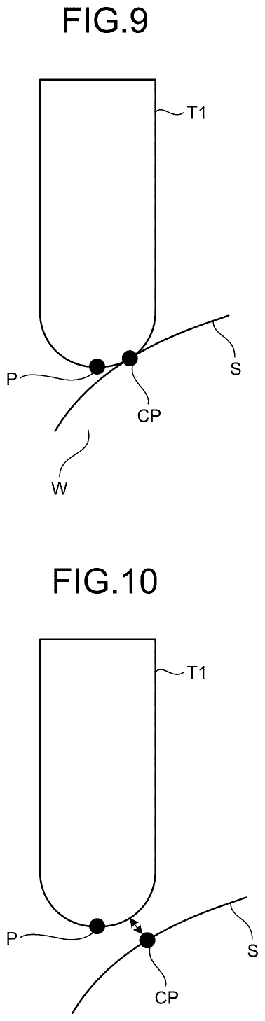

The cutting point calculation unit 106 of the cutting point information acquisition unit 10 calculates the position of the cutting point, which is the point at which the tool T1 attached to the machine tool cuts the workpiece W, based on the tool trajectory TP1 stored in the tool trajectory storage unit 103, the tool information stored in the tool information storage unit 104, and the machining target shape M1 stored in the machining target shape storage unit 105. Here, the cutting point will be described. FIG. 9 is a diagram for explaining the relationship between the tip point P of the tool T1 and the cutting point CP. The tip point P is a point located at the tip of the tool T1, and the position thereof on the tool T1 does not change. The cutting point CP is a point at which the tool T1 cuts the workpiece W, and is ideally a point at which the tool T1 contacts the machining curved surface S of the workpiece W. FIG. 9 illustrates the cutting point CP in contact with the machining curved surface S.

The cutting point calculation unit 106 calculates the position of the cutting point CP corresponding to each of the plurality of tip points P included in the tool trajectory TP1. Specifically, for each of the plurality of tip points P included in the tool trajectory TP1, the cutting point calculation unit 106 calculates the cutting point CP of the tool T1 with respect to the machining curved surface S, which is on the machining curved surface S of the machining target shape M1 based on the position of the tip point P and the tool direction V. Because the position of the tip point P and the tool direction V are a relative position and a relative direction with respect to the machining target shape M1, a relative positional relationship between the tool T1 and the machining curved surface S of the machining target shape M1 is determined according to the position of the tip point P and the tool direction V, and this positional relationship is ideally a state in which the tool T1 and the machining curved surface S are in contact with each other. Therefore, when the tool T1 and the machining curved surface S are in contact with each other as illustrated in FIG. 9, the cutting point calculation unit 106 obtains, as the cutting point CP, a point at which the tool T1 and the machining curved surface S are in contact with each other on the machining curved surface S.

However, in practice, an error is included in the position of the tip point P of the tool and the tool direction V, and thus the tool T1 and the machining curved surface S may not be in contact with each other. For example, there may be a case where the tool T1 disposed according to the position of the tip point P calculated based on the operational information is away from the machining curved surface S. FIG. 10 is a diagram for explaining the cutting point CP of the tool T1 which is away from the machining curved surface S. When the tool T1 is away from the machining curved surface S as illustrated in FIG. 10, the cutting point calculation unit 106 can obtain one point on the machining curved surface S at which the distance between the tool T1 and the machining curved surface S is the shortest, and set this point as the cutting point CP.

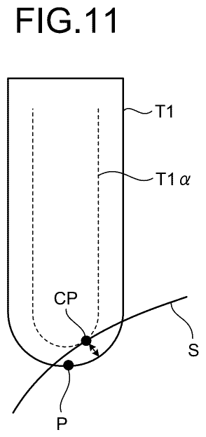

In addition, there may be a case where the tool T1 disposed according to the position of the tip point P calculated based on the operational information interferes with the machining curved surface S. FIG. 11 is a diagram for explaining the cutting point CP of the tool T1 which interferes with the machining curved surface S. When the tool T1 interferes with the machining curved surface S as illustrated in FIG. 11, assuming that the tool T1 offset to come into contact with the machining curved surface S is an offset tool T1α, the cutting point calculation unit 106 can obtain a point at which the offset tool T1α and the machining curved surface S are in contact with each other, and set this point as the cutting point CP. Although an example in which the tool T1 is a ball end mill is illustrated here, the cutting point CP can be calculated with a similar method even for the tool T1 that has a special shape such as a radius end mill, a flat end mill, a barrel tool, or a turning tool.

The cutting point calculation unit 106 stores, in the cutting point storage unit 107, cutting point information in which the positions of the plurality of cutting points CP obtained with the above-described method are associated with the corresponding tip points P. Depending on the relationship between the tool T1 and the machining curved surface S, a plurality of cutting points CP may be calculated for one tip point P. In this case, the plurality of cutting points CP may be stored in association with the one tip point P.

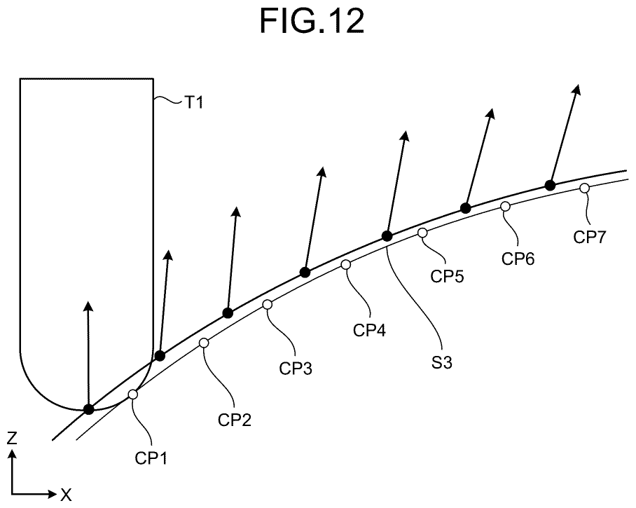

FIG. 12 is a diagram illustrating cutting points CP1 to CP7 calculated corresponding to the tip points P1 to P7 illustrated in FIG. 8, respectively. Although reference signs are omitted in FIG. 12 for the sake of simplicity, black circles (namely, filled-circle symbols) illustrated in FIG. 12 are the tip points P1 to P7 illustrated in FIG. 8, and arrows illustrated in FIG. 12 are the tool directions V1 to V7 illustrated in FIG. 8. FIG. 12 illustrates the cutting points CP1 to CP7 of the tool T1 with respect to the machining curved surface S3 when the tool T1 moves on the machining curved surface S3 of the machining target shape M1 according to the plurality of tip points P1 to P7 and the tool directions V1 to V7 included in the tool trajectory TP1. The cutting points CP1 to CP7 respectively corresponding to the tip points P1 to P7 are calculated.

The feature calculation unit 108 of the feature acquisition unit 20 calculates a feature of machining corresponding to each of the plurality of tip points P included in the tool trajectory TP1 based on the operational information stored in the operational information storage unit 101, the tool trajectory TP1 stored in the tool trajectory storage unit 103, and the cutting point information stored in the cutting point storage unit 107. The feature calculation unit 108 stores the calculated feature in the feature storage unit 109 in association with the cutting point CP. The feature calculation unit 108 may directly associate the feature with the cutting point CP, or associate the feature with the tip point P to regard the features associated with a common tip point P as the features corresponding to the cutting point CP.

The feature is an amount representing a characteristic of machining. The feature includes, for example, at least one of machining error amount that is a distance between the machining target shape M1 and the tool T1 disposed according to the position of the tip point P, speed of the tip point P, acceleration of the tip point P, jerk of the tip point P, speed of the cutting point CP, acceleration of the cutting point CP, jerk of the cutting point CP, position of each of the plurality of drive shafts of the machine tool, speed of each of the plurality of drive shafts of the machine tool, acceleration of each of the plurality of drive shafts of the machine tool, jerk of each of the plurality of drive shafts of the machine tool, or reverse position of each of the plurality of drive shafts of the machine tool.

Here, the machining error amount can be calculated as the shortest distance between the position of the cutting point CP corresponding to the tip point P of the tool T1 and the shape surface of the tool T1 disposed according to the position of the tip point P and the tool direction V.

The speed, acceleration, and jerk of the tip point P of the tool T1 can be calculated as follows. Given that the position of the tip point P at a certain time t is PT(t), and the position of the tip point P at time t+Δt advanced from time t by the time period corresponding to a predetermined control cycle is PT(t+Δt), the speed VT(t) of the tip point P at time t is obtained by dividing the distance between the positions of the two tip points P by the time period corresponding to the predetermined control cycle, and is expressed by Formula (1) below.

$$\begin{matrix}Formula 1 & \\ VT ( t ) = \frac{PT ( t + Δ t ) - PT ( t )}{Δ t} & ( 1 )\end{matrix}$$

The acceleration AT(t) of the tip point P at time t is expressed by Formula (2).

$$\begin{matrix}Formula 2 & \\ AT ( t ) = \frac{VT ( t + Δ t ) - VT ( t )}{Δ t} & ( 2 )\end{matrix}$$

The jerk JT(t) of the tip point P at time t is expressed by Formula (3).

$$\begin{matrix}Formula 3 & \\ JT ( t ) = \frac{AT ( t + Δ t ) - AT ( t )}{Δ t} & ( 3 )\end{matrix}$$

The speed, acceleration, and jerk of the cutting point CP can be calculated as follows. Given that the position of the cutting point CP corresponding to the tip point P at a certain time t is PC(t), and the position of the cutting point CP corresponding to the tip point P at time t+Δt advanced from time t by the time period corresponding to a predetermined control cycle is PC(t+Δt), the speed VC(t) of the cutting point CP corresponding to the tip point P at time t is expressed by Formula (4) below.

$$\begin{matrix}Formula 4 & \\ VC ( t ) = \frac{PC ( t + Δ t ) - PC ( t )}{Δ t} & ( 4 )\end{matrix}$$

In addition, the acceleration AC(t) of the cutting point CP corresponding to the tip point P at time t is expressed by Formula (5).

$$\begin{matrix}Formula 5 & \\ A C ( t ) = \frac{VC ( t + Δ t ) - VC ( t )}{Δ t} & ( 5 )\end{matrix}$$

In addition, the jerk JC(t) of the cutting point CP corresponding to the tip point P at time t is expressed by Formula (6).

$$\begin{matrix}Formula 6 & \\ JC ( t ) = \frac{A C ( t + Δ t ) - A C ( t )}{Δ t} & ( 6 )\end{matrix}$$

The position, speed, acceleration, and jerk of each of the plurality of drive shafts of the machine tool can be calculated as follows. The position PM1(t) of a first drive shaft corresponding to the tip point P at a certain time t can be acquired from the time-series data of the operational information.

Given that the position of the first drive shaft corresponding to the tip point P at time t+Δt advanced from time t by the time period corresponding to a predetermined control cycle is PM1(t+Δt), the speed VM1(t) of the first drive shaft corresponding to the tip point P at time t is expressed by Formula (7) below.

$$\begin{matrix}Formula 7 & \\ VM 1 ( t ) = \frac{PM 1 ( t + Δ t ) - PM 1 ( t )}{Δ t} & ( 7 )\end{matrix}$$

In addition, the acceleration AM1(t) of the first drive shaft corresponding to the tip point P at time t is expressed by Formula (8).

$$\begin{matrix}Formula 8 & \\ AM 1 ( t ) = \frac{VM 1 ( t + Δ t ) - VM 1 ( t )}{Δ t} & ( 8 )\end{matrix}$$

In addition, the jerk JM1(t) of the first drive shaft corresponding to the tip point P at time t is expressed by Formula (9).

$$\begin{matrix}Formula 9 & \\ JM 1 ( t ) = \frac{AM 1 ( t + Δ t ) - AM 1 ( t )}{Δ t} & ( 9 )\end{matrix}$$

The position, speed, acceleration, and jerk of any other drive shaft than the first drive shaft can be calculated with a similar method.

The reverse position of each of the plurality of drive shafts of the machine tool can be calculated as follows. With the above-described method, the speed VM1(t) of the first drive shaft corresponding to the tip point P at a certain time t and the speed VM1(t+Δt) of the first drive shaft corresponding to the tip point P at time t+Δt advanced from time t by the time period corresponding to a predetermined control cycle are calculated. At this time, the sign of the speed VM1(t) is compared with the sign of the speed VM(t+Δt), and the position corresponding to the time when the sign is inverted can be set as the reverse position of the first drive shaft. The reverse position of any other drive shaft than the first drive shaft can be obtained with a similar method.

Furthermore, the feature calculation unit 108 can also use a difference in feature between two adjacent tip points P as the feature. At this time, the two adjacent tip points P are a set of two tip points P having the shortest distance on two adjacent tool trajectories. For example, in a CAD/CAM system, for a tool trajectory of what is called scanning line machining or contour line machining generated in parallel on a plane and at a constant pitch, or for a tool trajectory of what is called along-surface machining generated at a constant pitch based on the contour of the machining curved surface S of the machining target shape M1, two adjacent tip points P are obtained by selecting the closest tip point P on an adjacent tool trajectory passing through a position separated by the pitch with respect to a certain tip point P.

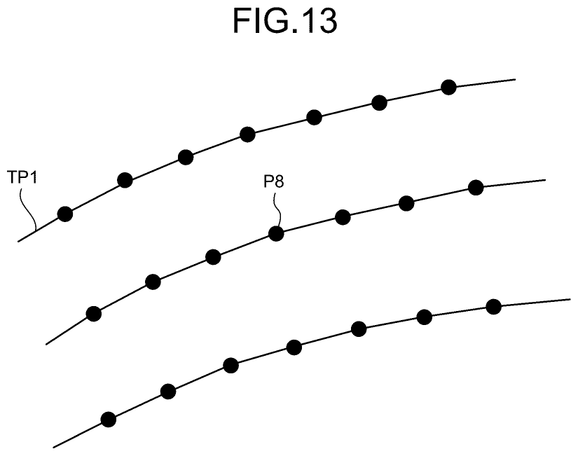

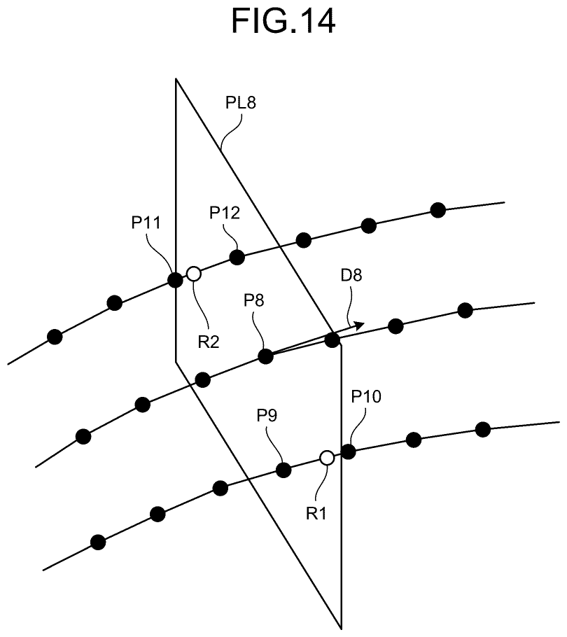

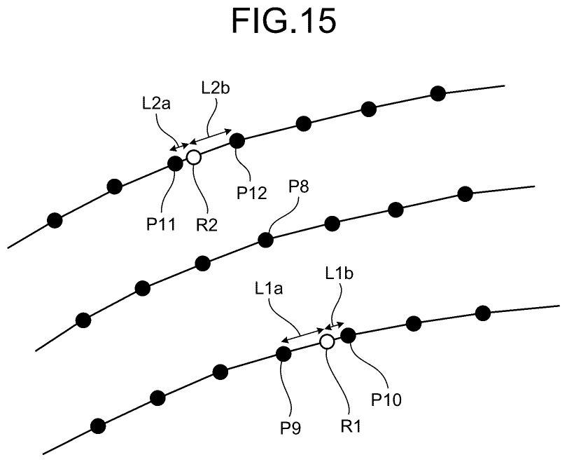

Here, a method of obtaining the tip point P adjacent to an arbitrary tip point P included in the tool trajectory TP1 will be described with reference to FIGS. 13 to 15. FIG. 13 is a first diagram for explaining a method of obtaining the tip point P adjacent to an arbitrary tip point P included in the tool trajectory TP1. FIG. 14 is a second diagram for explaining a method of obtaining the tip point P adjacent to an arbitrary tip point P included in the tool trajectory TP1. FIG. 15 is a third diagram for explaining a method of obtaining the tip point P adjacent to an arbitrary tip point P included in the tool trajectory TP1. FIG. 13 illustrates the tip point P8 included in the tool trajectory TP1 and a part of the tool trajectory around the tip point P8. Consider a case where the tip point P adjacent to the tip point P8 is obtained. As illustrated in FIG. 14, first, assume a plane PL8 having a traveling direction D8 at the tip point P8 as a normal vector. Here, the traveling direction D8 may be obtained from the relationship between the tip point P8 and the front and rear tip points P, or may be a direction which is separately predetermined. Next, the feature calculation unit 108 obtains an intersection point between the assumed plane PL8 and the tool trajectory. At this time, an intersection point R1 located between the tip points P9 and P10 and an intersection point R2 located between the tip points P11 and P12 are obtained.

Next, as illustrated in FIG. 15, the feature calculation unit 108 obtains a distance L1a between the intersection point R1 and the tip point P9 and a distance L1b between the intersection point R1 and the tip point P10. By comparing the distances L1a and L1b, the feature calculation unit 108 sets the tip point P10 having a shorter distance from the intersection point R1 among the tip points P9 and P10 as a candidate for the adjacent tip point P. Similarly, the feature calculation unit 108 obtains a distance L2a between the intersection point R2 and the tip point P11 and a distance L2b between the intersection point R2 and the tip point P12. By comparing the distances L2a and L2b, the feature calculation unit 108 sets the tip point P11 having a shorter distance from the intersection point R2 among the tip points P11 and P12 as a candidate for the adjacent tip point P. The feature calculation unit 108 may select, from among the plurality of candidate tip points P10 and P11 obtained here, one having a shorter distance from the tip point P8 or one present in a specific direction with respect to the traveling direction D8. Here, suppose that the tip point P11 adjacent to the tip point P8 is selected. In this case, the feature calculation unit 108 can set a difference in feature, which is value obtained by subtracting the feature of the tip point P11 from the feature of the tip point P8, as a new feature of the tip point P8.

Note that the features described in detail above are examples, and the feature calculation unit 108 can calculate physical information such as the load and current value of the spindle of the machine tool and the internal temperature of the machine tool for each of the tip points P and store the physical information in the feature storage unit 109. In addition, the feature calculation unit 108 may calculate one type of feature or may simultaneously calculate and store two or more types of features. Further, the feature calculation unit 108 may output the feature or the features as image data or time-series data.

Returning to FIG. 1, the machining defect region extraction unit 114 of the machining defect analysis unit 110 extracts a machining defect region, that is a region in which a machining defect of the workpiece W occurs, based on the cutting point information stored in the cutting point storage unit 107 and the feature stored in the feature storage unit 109. The machining defect region extraction unit 114 can extract one or more machining defect regions.

The machining defect analysis unit 110 extracts a machining defect region based on the position of the cutting point CP indicated by the cutting point information and the feature of the tip point P corresponding to the cutting point CP. A possible method for extracting a machining defect region involves, for example, extracting the cutting point CP corresponding to a feature exceeding a predetermined threshold, and extracting a region in which a plurality of cutting points CP among the extracted cutting points CP are located close to each other on the machining curved surface S as one machining defect region. At this time, a plurality of machining defect regions may be extracted.

Another possible method for extracting a machining defect region involves, for example, calculating the amount of change in feature between a certain cutting point CP and a peripheral cutting point CP, sequentially obtaining the boundary between cutting points CP at which the feature sharply changes, and extracting the region of the cutting points CP present inside the region surrounded by the obtained boundary as one machining defect region.

At this time, for example, in the case of using a machining error amount as a feature, a region in which the machining error amount exceeds a predetermined threshold can be extracted as a machining defect region, or a region surrounded by a boundary at which the machining error amount sharply changes can be extracted as a machining defect region. In addition, for example, in the case of using the acceleration of the tip point P as a feature, a region in which the acceleration of the tip point P exceeds a predetermined threshold can be extracted as a machining defect region, or a region surrounded by a boundary at which the acceleration of the tip point P sharply changes can be extracted as a machining defect region. In addition, a machining defect region may be extracted based on one feature or may be extracted based on a plurality of features.

A still another possible method for extracting a machining defect region involves, for example, generating an image in which each of a plurality of cutting points CP is shown using an expression method indicating a feature corresponding to the cutting point CP, that is, an image in which the cutting points CP are individually shown according to the feature, obtaining a range in the image by performing image processing such as correction, conversion, filter processing, and image feature extraction on the generated image, and extracting the region of the cutting points CP present inside the obtained range as one machining defect region. For example, in the case of using an image in which the plurality of cutting points CP are shown in darker colors as the magnitude of the features corresponding to the cutting points CP increases, it is possible to extract a region in which the magnitude of the feature is equal to or greater than the threshold by obtaining the range in the image in which the color density of the image is equal to or greater than the threshold.

The machining defect region extraction unit 114 can also extract a machining defect region based on a designated position designated by the position designation unit 112. The machining defect region extraction unit 114 can extract a region including at least a part of the designated position as a machining defect region. The position designation unit 112 receives designation of a position performed by the worker using an input means such as a pointing device, and outputs the received designated position to the machining defect region extraction unit 114. The designated position received by the position designation unit 112 may be one specific point, a plurality of points, or a continuous region.

Subsequently, the machining defect cause determination unit 115 of the machining defect analysis unit 110 determines the cause of the machining defect in the machining defect region based on the cutting point information stored in the cutting point storage unit 107 and the machining defect region extracted by the machining defect region extraction unit 114. If the machining defect region extraction unit 114 extracts a plurality of machining defect regions, the machining defect cause determination unit 115 can determine the cause of the machining defect for each machining defect region.

The machining defect cause determination unit 115 can determine the cause of the machining defect based on the extracted machining defect region and the feature corresponding to the cutting point CP included in the machining defect region. For example, the machining defect cause determination unit 115 can determine the cause of the machining defect by simply regarding the type of the feature used to extract the machining defect region as the cause of the machining defect.

As another method, the machining defect cause determination unit 115 can calculate, for the feature corresponding to the cutting point CP present inside the machining defect region, values inside and outside the machining defect region, a feature difference value in the vicinity of the boundary of the machining defect region, and the like, and check the correlation with the machining defect region for each feature, thereby regarding the type of feature having a high correlation as the cause of the machining defect. For example, in the case of determining the cause of the machining defect for a certain machining defect region, if the feature of the cutting point CP is the reverse position of the first drive shaft of the machine tool inside the machining defect region and not the reverse position of the first drive shaft of the machine tool outside the machining defect region, it can be determined that the cause of the machining defect in the machining defect region is the reverse position of the first drive shaft of the machine tool.

As still another method, the machining defect cause determination unit 115 may generate an image in which a machining defect region is shown and an image in which the cutting point CP present inside the machining defect region is shown using an expression method indicating a feature, perform image processing such as correction, conversion, filter processing, and image feature extraction on these generated two images, and then compare the two images to determine the cause of the machining defect. In this case, the machining defect cause determination unit 115 can determine the feature having the highest correlation between the two images as the cause of the machining defect.

Further, a cause pattern, which is information in which the cause of a machining defect is associated with the pattern of the feature that appears when the cause presents, may be stored in the cause pattern storage unit 113, and the machining defect cause determination unit 115 may identify the cause of the machining defect in the machining defect region based on the extracted machining defect region, the feature, and the cause pattern. The cause pattern is, for example, a pattern in which the cutting point CP, which presents inside, at the boundary, and outside the machining defect region, appears, a correlation between patterns that appear between a plurality of features, a relationship between a region in which the feature is equal to or greater than a predetermined value and the machining defect region, and the like. Further, the cause pattern may be associated with the shape and size of the machining defect region.

More specifically, for example, assuming that cause pattern #A to be that the machining error amount and the acceleration of the tip point P are equal to or greater than a predetermined value and have a positive correlation inside the machining defect region, and it can be determined whether cause pattern #A applies or not based on the actual machining defect region and the feature. In addition, if a plurality of cause patterns are applicable, the machining defect cause determination unit 115 may obtain the determination probability for each cause pattern.

The display unit 111 displays the machining defect region extracted by the machining defect analysis unit 110 using the expression method that is different depending on each of the cause of the machining defect in the machining defect region.

Here, a method with which the display unit 111 displays the machining defect region using the expression method that is different depending on each of the cause of the machining defect will be described with examples. For example, the display unit 111 determines a color in advance for each cause of machining defect, and displays the cutting point CP included in the machining defect region using the color predetermined for the cause of the machining defect in the machining defect region. In addition, the display unit 111 may determine a display symbol in advance for each cause of machining defect, and display the cutting point CP included in the machining defect region using the display symbol predetermined for the cause of the machining defect in the machining defect region. In addition, the display unit 111 may determine a display density and a size in advance for each cause of machining defect, and display the cutting point CP included in the machining defect region using, for example, a point of the predetermined size with the display density predetermined for the cause of the machining defect in the machining defect region.

In addition, the display unit 111 may generate a line segment indicating the boundary of the machining defect region, and display the line segment according to a predetermined display type such as display color, solid line, or broken line. Furthermore, the display unit 111 may fill the inside of the boundary of the machining defect region with some color. By using these expression methods, the display unit 111 can display the machining defect region using the expression method that is different depending on each of the cause of the machining defect.

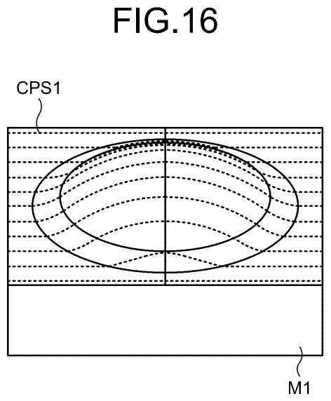

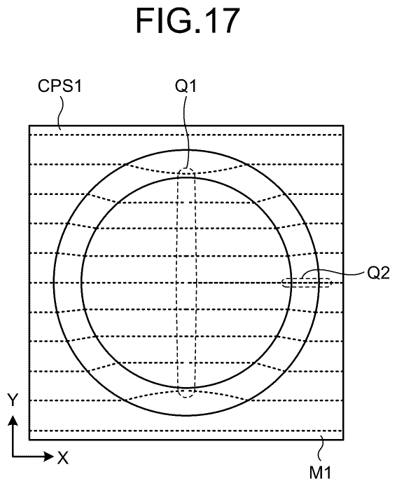

FIG. 16 is a perspective view illustrating an example of a display screen displayed by the machining defect analysis device 1 illustrated in FIG. 1. FIG. 17 is a top view illustrating an example of a display screen displayed by the machining defect analysis device 1 illustrated in FIG. 1. In FIGS. 16 and 17, for a cutting point group CPS1 which is a set of cutting points CP obtained for each of the plurality of tip points P included in the tool path TP1, the cutting points CP in the machining defect region are displayed by being superimposed on the machining target shape M1 using the expression method that is different depending on each of the cause of the machining defect in each machining defect region. Here, the display unit 111 sets the display color of the cutting point CP present inside a machining defect region Q1 to a first display color different from the display color of the cutting point CP present outside the machining defect region Q1, and displays a line segment indicating the boundary of the machining defect region Q1 with a broken line of the first display color. In addition, the display unit 111 sets the display color of the cutting point CP present inside a machining defect region Q2 different from the machining defect region Q1 to a second display color different from the display color of CP present outside the machining defect region Q2, and displays a line segment indicating the boundary of the machining defect region Q2 with a broken line of the second display color. For example, the first display color can be red and the second display color can be green. Here, the display unit 111 may allow the worker to designate the expression method to be used for each cause of machining defect, and use the designated expression method.

In addition, when there is a plurality of candidates for the cause of machining defect in one machining defect region, the display unit 111 may display the determination probability for each cause of machining defect determined for each of the machining defect regions. At this time, the determination probability for each cause of machining defect obtained by the machining defect analysis unit 110 is used as the determination probability. More specifically, for example, in a case where the probability that the cause of the machining defect in a certain machining defect region is cause pattern #A is 70% and the probability that the cause is cause pattern #B is 30%, the display unit 111 may display these probabilities. Furthermore, the display unit 111 may display the feature that is a reason for the cause of the machining defect identified for the machining defect region.

The display unit 111 can also display, in an overlapping manner, the display result in which the machining curved surface S of the machining target shape M1 is displayed using the expression method indicating the feature of the tip point P corresponding to each of the plurality of cutting points CP and the display result in which the machining defect region is displayed using the expression method that is different depending on each of the cause of the machining defect.

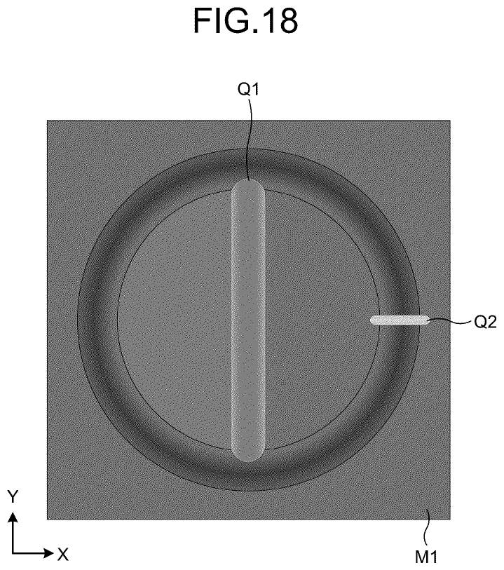

FIG. 18 is a diagram illustrating an example of a screen on which the display result in which the machining curved surface S of the machining target shape M1 is displayed in the display color indicating the feature and the display result in which each of the machining defect regions Q1 and Q2 is displayed using the expression method that is different depending on each of the cause of the machining defect are displayed in an overlapping manner.

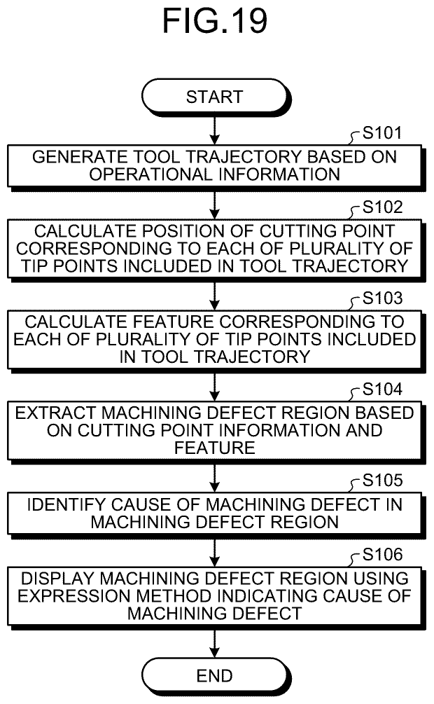

FIG. 19 is a flowchart for explaining the operation of the machining defect analysis device 1 illustrated in FIG. 1. The tool trajectory calculation unit 102 of the machining defect analysis device 1 generates the tool trajectory TP1 based on the operational information stored in the operational information storage unit 101, and stores the generated tool trajectory TP1 in the tool trajectory storage unit 103 (step S101). The cutting point calculation unit 106 calculates the position of the cutting point CP corresponding to each of the plurality of tip points P included in the tool trajectory TP1 stored in the tool trajectory storage unit 103, and stores cutting point information indicating the calculated position of the cutting point CP in the cutting point storage unit 107 (step S102). The feature calculation unit 108 calculates a feature corresponding to each of the plurality of tip points P included in the tool trajectory TP1 based on the operational information stored in the operational information storage unit 101, the tool trajectory TP1 stored in the tool trajectory storage unit 103, and the cutting point information stored in the cutting point storage unit 107, and stores the calculated feature in the feature storage unit 109 (step S103).

The machining defect region extraction unit 114 extracts a machining defect region based on the cutting point information stored in the cutting point storage unit 107 and the feature stored in the feature storage unit 109 (step S104).

The machining defect cause determination unit 115 identifies the cause of the machining defect in the machining defect region extracted by the machining defect region extraction unit 114 (step S105). The display unit 111 displays the extracted machining defect region using the expression method that is different depending on each of the cause of the identified machining defect (step S106).

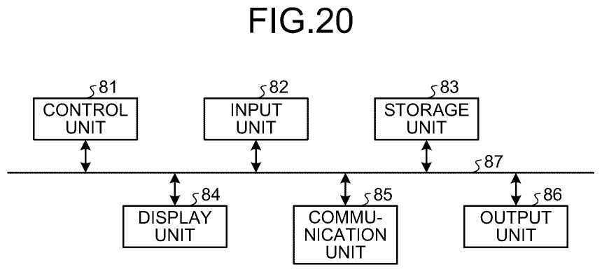

FIG. 20 is a diagram illustrating an exemplary configuration of a computer system that implements the machining defect analysis device 1 according to the first embodiment. As illustrated in FIG. 20, this computer system includes a control unit 81, an input unit 82, a storage unit 83, a display unit 84, a communication unit 85, and an output unit 86, which are connected to one another via a system bus 87.

In FIG. 20, the control unit 81 is, for example, a central processing unit (CPU) or the like. The control unit 81 executes an analysis program describing each process that is performed by the machining defect analysis device 1. The input unit 82 includes, for example, a touch sensor, a keyboard, a mouse, and the like, and is used by the user of the computer system to input various types of information. In the above embodiment, in the case of receiving worker input, the reception of worker input can be performed using the input unit 82. The storage unit 83 includes various types of memories such as a random access memory (RAM) and a read only memory (ROM) and a storage device such as a hard disk. The storage unit 83 stores, for example, programs to be executed by the control unit 81 and necessary data obtained during processing. The storage unit 83 is also used as a temporary storage area for programs. The display unit 84 includes a liquid crystal display (LCD) panel or the like, and displays various screens to the user of the computer system. The communication unit 85 is a communication circuit or the like that performs communication processing. The communication unit 85 may include a plurality of communication circuits corresponding to each of a plurality of communication schemes. The output unit 86 is an output interface that outputs data to an external device such as a printer or an external storage device.

Note that FIG. 20 is an example, and the configuration of the computer system is not limited to the example in FIG. 20. For example, the computer system need not include the output unit 86. In addition, in a case where the machining defect analysis device 1 is implemented by a plurality of computer systems, not all of these computer systems need to be the computer system illustrated in FIG. 20. For example, some computer systems need not include at least one of the display unit 84, the output unit 86, and the input unit 82 illustrated in FIG. 20.

Here, an example of the operation of the computer system that is performed until the analysis program describing the processes of the machining defect analysis device 1 becomes executable will be described. In the computer system having the above-mentioned configuration, for example, the analysis program describing the operation of the machining defect analysis device 1 is installed on the storage unit 83 from a compact disc (CD)-ROM or digital versatile disc (DVD)-ROM set in a CD-ROM drive or DVD-ROM drive (not illustrated). Then, when the analysis program is executed, the analysis program read from the storage unit 83 is stored in the area of the main storage device in the storage unit 83. In this state, the control unit 81 executes the processes as the machining defect analysis device 1 in accordance with the analysis program stored in the storage unit 83.

In the above description, the program describing the processes in the machining defect analysis device 1 is provided using a CD-ROM or DVD-ROM as a recording medium. Alternatively, the program may be provided by a transmission medium such as the Internet via the communication unit 85 according to the configuration of the computer system, the capacity of the program, and the like.

The analysis program according to the present embodiment causes a computer to execute: a step of acquiring cutting point information indicating the position of the cutting point CP that is a point at which a tool attached to a machine tool cuts the workpiece W, the cutting point corresponding to each of a plurality of tip points P included in a tool trajectory that is information indicating a movement path of the tip point P of the tool; a step of acquiring a feature indicating a characteristic of machining, the feature being calculated corresponding to each of the plurality of tip points P; and a step of identifying, based on the cutting point information and the feature, a machining defect region in which a machining defect of the workpiece W occurs and a cause of the machining defect in the machining defect region.

The operational information storage unit 101, the tool trajectory storage unit 103, the tool information storage unit 104, the machining target shape storage unit 105, the cutting point storage unit 107, the feature storage unit 109, and the cause pattern storage unit 113 illustrated in FIG. 1 are a part of the storage unit 83 illustrated in FIG. 20. Each of the tool trajectory calculation unit 102, the cutting point calculation unit 106, the position designation unit 112, the machining defect region extraction unit 114, the machining defect cause determination unit 115, and the display unit 111 illustrated in FIG. 1 is implemented by using the control unit 81, the input unit 82, the storage unit 83, and the display unit 84.

Note that the division of the functions in the machining defect analysis device 1 illustrated in FIG. 1 is an example, and the method of dividing the functional units is not limited to the example illustrated in FIG. 1 as long as the machining defect analysis device 1 can perform the above-described operation. In FIG. 1, the machining defect analysis device 1 performs all the operations, but a plurality of devices may be used to implement similar functions. For example, in FIG. 1, the machining defect analysis device 1 also has the function of generating information to be used by the machining defect analysis unit 110. However, as described below as a modification, a device having the machining defect analysis function and a device having the function of calculating the cutting point CP and the feature may be separately provided.

### <Modification>

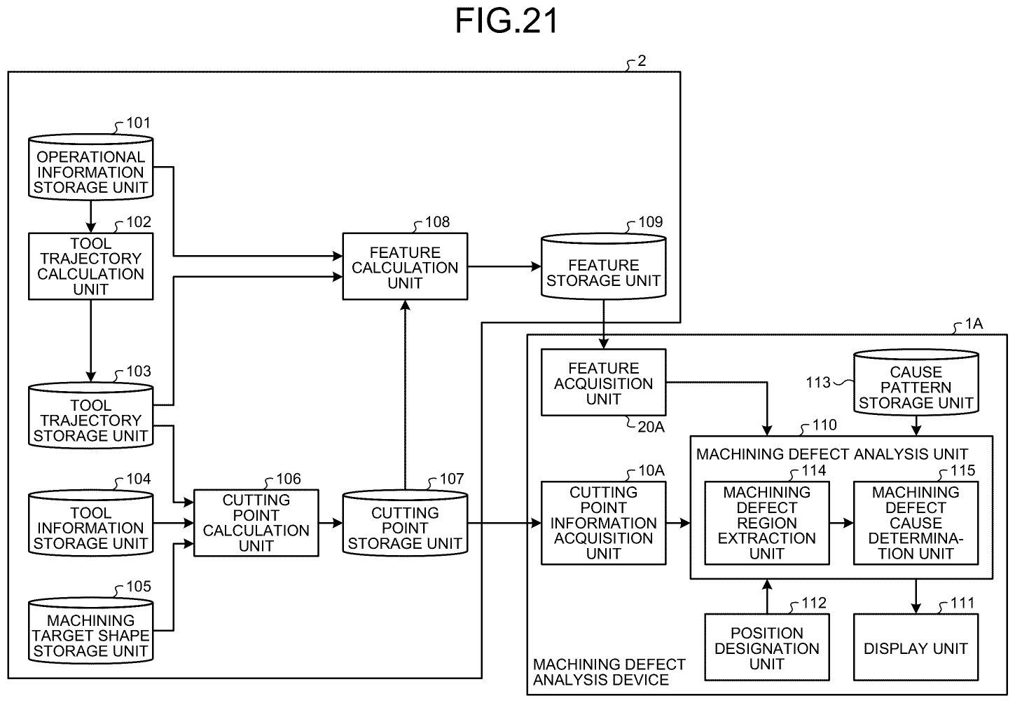

FIG. 21 is a diagram illustrating a functional configuration of a modification of the first embodiment. In the modification, the machining defect analysis device 1A includes a cutting point information acquisition unit 10A, a feature acquisition unit 20A, the machining defect analysis unit 110, the display unit 111, the position designation unit 112, and the cause pattern storage unit 113. An information processing device 2 is a device, such as a server, different from the machining defect analysis device 1A, and includes the operational information storage unit 101, the tool trajectory calculation unit 102, the tool trajectory storage unit 103, the tool information storage unit 104, the machining target shape storage unit 105, the cutting point calculation unit 106, the cutting point storage unit 107, the feature calculation unit 108, and the feature storage unit 109.

Whereas the cutting point information acquisition unit 10 of the machining defect analysis device 1 includes the cutting point calculation unit 106 and the cutting point storage unit 107 and has the function of generating cutting point information, the cutting point information acquisition unit 10A of the machining defect analysis device 1A acquires cutting point information from the information processing device 2. In addition, whereas the feature acquisition unit 20 of the machining defect analysis device 1 includes the feature calculation unit 108 and the feature storage unit 109 and has the function of calculating the feature, the feature acquisition unit 20A of the machining defect analysis device 1A acquires the feature from the information processing device 2. Other functional units, which are denoted by the same reference signs as those in FIG. 1, have functions similar to those of the machining defect analysis device 1, and thus a detailed description thereof will be omitted.

Similarly to the machining defect analysis device 1, the machining defect analysis device 1A and the information processing device 2 can also be implemented by using one or more computer systems such as the one illustrated in FIG. 20. In this case, each of the cutting point information acquisition unit 10A and the feature acquisition unit 20A can be implemented using the communication unit 85. In addition, the division of the functional units in the machining defect analysis device 1A and the information processing device 2 illustrated in FIG. 21 is an example, and the method of dividing the functional units is not limited to the example illustrated in FIG. 21 as long as functions similar to those of the machining defect analysis device 1 can be implemented as the entire system. For example, the function of the machining defect region extraction unit 114 and the function of the machining defect cause determination unit 115 may be implemented by different pieces of hardware. The functions of the information processing device 2 can also be implemented by a plurality of pieces of hardware. Some of the functions of the machining defect analysis device 1A and the functions of the information processing device 2 can also be implemented by a cloud system. In the cloud system, it is possible to freely set division of the hardware of the computer system and devices such as a server for each function. For example, one computer system may have a function as a plurality of devices, or a plurality of computer systems may have a function as one device.

As described above, the machining defect analysis device 1 or 1A according to the first embodiment includes: the cutting point information acquisition unit 10 or 10A that acquires cutting point information indicating a position of the cutting point CP that is a point at which a tool attached to a machine tool cuts the workpiece W, the cutting point CP corresponding to each of a plurality of tip points P included in a tool trajectory that is information indicating a movement path of the tip point P of the tool; the feature acquisition unit 20 or 20A that acquires a feature indicating a characteristic of machining, the feature being calculated corresponding to each of the plurality of tip points P; and the machining defect analysis unit 110 that identifies, based on the cutting point information and the feature, a machining defect region in which a machining defect of the workpiece W occurs and a cause of the machining defect in the machining defect region. The machining defect analysis unit 110 includes: the machining defect region extraction unit 114 that extracts the machining defect region based on the cutting point information and the feature; and the machining defect cause determination unit 115 that identifies a cause of a machining defect in the machining defect region based on the feature and the machining defect region extracted. With the machining defect analysis device 1 or 1A having the above-described configuration, it is possible to identify which part of the workpiece W has a machining defect, and to reduce the worker's labor for the analysis work of identifying the cause of the machining defect. Thus, it is possible to take appropriate measures against machining defects, reduce rework such as reprocessing, and improve productivity.

The machining defect analysis device 1 or 1A further includes the display unit 111 that displays the extracted machining defect region using the expression method that is different depending on each of the cause of the machining defect. This makes it easier for the worker to grasp the cause of the machining defect occurring in the machining defect region, and makes it possible to further reduce the worker's labor for the analysis work. If a plurality of machining defect regions are extracted, the machining defect analysis unit 110 identifies the cause of the machining defect for each machining defect region, and the display unit 111 displays the machining defect region using the expression method that is different depending on each of the cause of the machining defect for each machining defect region.

The display unit 111 can also display the feature that is a reason for the cause of the machining defect identified for the extracted machining defect region. With the display unit 111 having such a function, it is possible to further reduce the worker's labor for the analysis work. In addition, when there is a plurality of candidates for the cause of machining defect in one machining defect region, the display unit 111 can display the determination probability for each cause of machining defect. With the display unit 111 having such a function, the worker can grasp that there is a plurality of candidates for the cause of machining defect and the determination probability for each cause, and the worker's labor for the analysis work can be further reduced.

The machining defect analysis device 1 or 1A can further include the position designation unit 112 that receives a designated position that is a position designated on the machining target shape M1 of the workpiece W, and the machining defect analysis unit 110 can extract a region including the designated position as the machining defect region. With the machining defect analysis device 1 or 1A having the above-described functions, when the worker grasps an approximate position of the machining defect region by looking at the actual workpiece W after machining, for example, the worker can designate the portion and analyze the cause of the machining defect. Thus, the intention of the worker can be reflected in the display result, and therefore the worker's labor for the analysis work can be further reduced.

The machining defect analysis device 1 or 1A can further include the cause pattern storage unit 113 that stores a cause pattern that is information in which a cause of a machining defect is associated with a pattern of the feature in presence of the cause, and the machining defect analysis unit 110 can identify the cause of the machining defect in the machining defect region extracted based on the machining defect region extracted, the feature, and the cause pattern. With the machining defect analysis device 1 or 1A having such a function, when the correspondence between the cause of machining defect and the pattern of feature is known in advance from a past analysis result or the like, the past analysis result can be utilized. Thus, the worker's labor for the analysis work can be further reduced.

### Second Embodiment

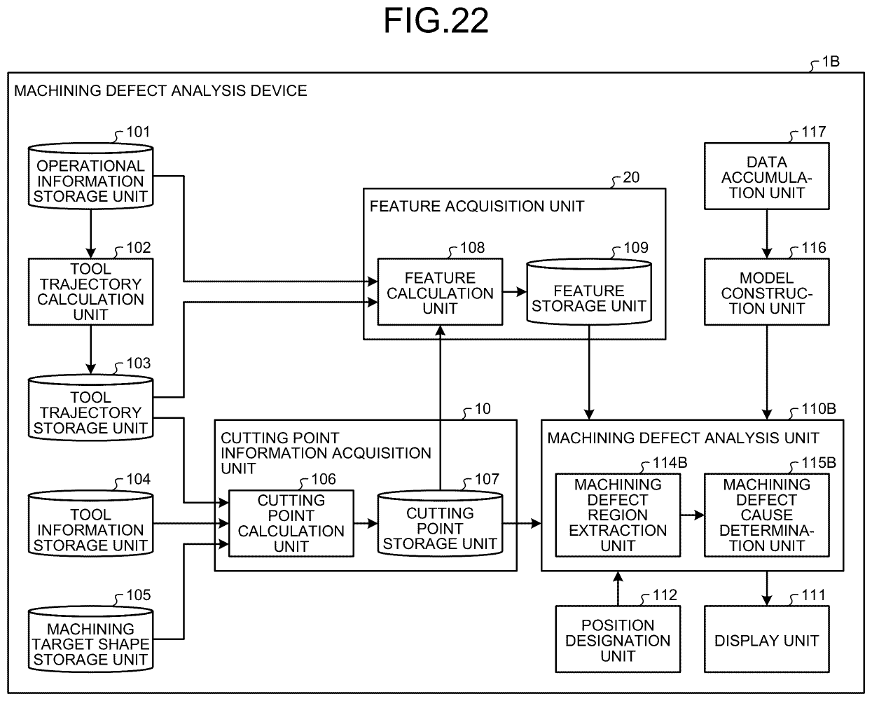

FIG. 22 is a diagram illustrating a functional configuration of a machining defect analysis device 1B according to the second embodiment. The target shape of machining in the machine tool varies depending on the machine to be used and the user, and the cause of a machining defect that occurs with respect to each target shape also varies. However, there are many cases where a certain user machines similar target shapes, and it is effective to utilize past machining results and simulation results for analysis of machining defects.

The machining defect analysis device 1B includes the operational information storage unit 101, the tool trajectory calculation unit 102, the tool trajectory storage unit 103, the tool information storage unit 104, the machining target shape storage unit 105, the cutting point information acquisition unit 10 including the cutting point calculation unit 106 and the cutting point storage unit 107, the feature acquisition unit 20 including the feature calculation unit 108 and the feature storage unit 109, a machining defect analysis unit 110B including a machining defect region extraction unit 114B and a machining defect cause determination unit 115B, the display unit 111, the position designation unit 112, a model construction unit 116, and a data accumulation unit 117.

The machining defect analysis device 1B is different from that of the first embodiment in that the machining defect analysis device 1B includes the model construction unit 116 and the data accumulation unit 117 instead of the cause pattern storage unit 113 of the machining defect analysis device 1 or 1A, and the machining defect analysis unit 110B analyzes a machining defect using a learned model constructed by the model construction unit 116. Hereinafter, differences from the first embodiment will be mainly described, and the description of similarities to the first embodiment will be omitted.

The data accumulation unit 117 accumulates data related to machining with the machine tool. For example, the cutting point CP and the feature are calculated for each trial of machining or simulation. Even for the workpiece W having the same machining target shape M1, in a case where machining is performed with different machines or in a case where the surrounding environment is different, different features are calculated. The data accumulation unit 117 associates the machining target shape, the tool information, the operational information, and the cutting points CP and features calculated from these data or information, and records it as accumulated information for each trial of past machining or simulation. Note that only the machining target shape M1, the tool information, and the operational information may be used as accumulated information, and the cutting points CP and features may be recalculated. If the cutting points CP and features are also accumulated, the processing time for recalculation can be shortened.

The model construction unit 116 generates a learned model for determining the cause of a machining defect using the accumulated information recorded in the data accumulation unit 117. The model construction unit 116 changes a model parameter, a hyperparameter, or a prediction model of an estimation model for estimating the cause of a machining defect. Here, an example in which a model parameter of a prediction model is changed using machine learning will be described.

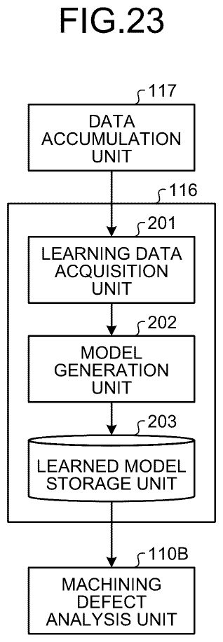

FIG. 23 is a diagram illustrating an exemplary configuration of the model construction unit 116 that uses machine learning. The model construction unit 116 includes a learning data acquisition unit 201, a model generation unit 202, and a learned model storage unit 203.

The learning data acquisition unit 201 acquires at least one feature as learning data based on the accumulated information in the data accumulation unit 117. In a case where the accumulated information includes a feature, the learning data acquisition unit 201 acquires the feature itself from the data accumulation unit 117. In a case where the accumulated information does not include a feature, the learning data acquisition unit 201 can calculate the feature based on the accumulated information and acquire the calculated feature as learning data. The learning data acquisition unit 201 outputs the acquired learning data to the model generation unit 202.

Note that the learning data acquisition unit 201 can acquire a feature for each cutting point CP as learning data. The learning data may be data of some cutting points CP or data of all the cutting points CP. In addition, in the learning data, the feature of one cutting point CP may be regarded as one set, or the feature of a plurality of points such as a plurality of adjacent points or points that are continuous in time series may be regarded as one set. Furthermore, the learning data acquisition unit 201 may acquire all types of features, or may acquire some types of features. In addition to the feature, the learning data acquisition unit 201 can also acquire information on the machining target shape M1, tool information, and the like as learning data.

The model generation unit 202 learns the cause of the machining defect based on the learning data output from the learning data acquisition unit 201. That is, a learned model for estimating the cause of the machining defect from the feature generated based on the operational information of the machine tool and the tool trajectory is generated.

As a learning algorithm that is used by the model generation unit 202, a known algorithm such as supervised learning, unsupervised learning, or reinforcement learning can be used. As an example, a case where k-means, which is unsupervised learning, is applied will be described. The unsupervised learning refers to a method of providing learning data that does not include a result to a learning device and thereby learning features in the learning data.

For example, the model generation unit 202 learns the cause of the machining defect through what is called unsupervised learning according to the grouping method that is based on the k-means.

The k-means is a non-hierarchical clustering algorithm, and is a method of classifying a given number of clusters into k using the mean of clusters.

Specifically, the k-means is processed in the following procedure. First, clusters are randomly allocated to pieces of data xi. Next, the center Vj of each cluster is calculated based on the allocated data. Next, the distance between each xi and each Vj is obtained, and xi is reassigned to the cluster which has the closest center. Then, if the assignment of the clusters of all xi has not changed in the above processing, or if the amount of change is below a preset threshold, it is determined that convergence has been reached, and the processing is terminated.

In the present embodiment, the cause of a machining defect is learned through what is called unsupervised learning according to learning data created based on at least one feature acquired by the learning data acquisition unit 201.

The model generation unit 202 executes learning in the above-described manner to generate a learned model, and outputs the generated learned model. Here, the worker can set, for each cluster, a label indicating the cause of a machining defect corresponding to each cluster of the learned model.

The learned model storage unit 203 stores the learned model output from the model generation unit 202. The learned model stored in the learned model storage unit 203 is used by the machining defect analysis unit 110B.

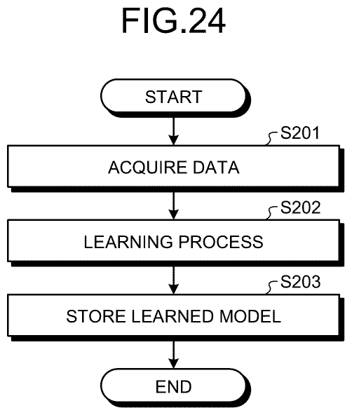

Next, the process of learning by the model construction unit 116 will be described with reference to FIG. 24. FIG. 24 is a flowchart related to learning processing performed by the machining defect analysis device 1B illustrated in FIG. 22.

The learning data acquisition unit 201 performs a data acquisition process of acquiring learning data including at least one feature (step S201). Note that, in a case where the learning data acquisition unit 201 acquires a plurality of features, the plurality of features only need to be input in association with each other: the plurality of features may be acquired at different timings or may be acquired simultaneously.

The model generation unit 202 performs a learning process of learning the cause of a machining defect through what is called unsupervised learning according to the learning data including at least one feature acquired by the learning data acquisition unit 201 and generating a learned model (step S202).

The learned model storage unit 203 stores the learned model generated by the model generation unit 202 (step S203).

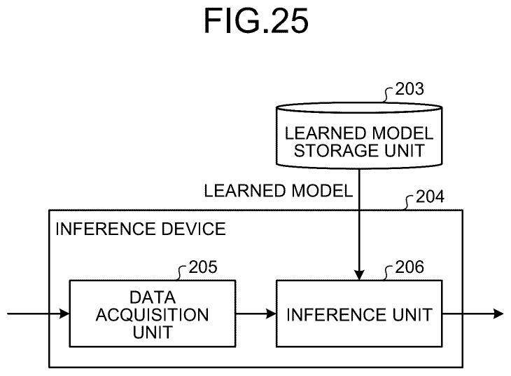

FIG. 25 is a diagram illustrating a functional configuration of an inference device 204 included in the machining defect analysis unit 110B illustrated in FIG. 22.

The machining defect analysis unit 110B has the function of the inference device 204 that estimates the cause of a machining defect using the learned model.

The inference device 204 includes a data acquisition unit 205 and an inference unit 206.

The data acquisition unit 205 acquires at least one feature from the feature acquisition unit 20. Here, the data acquisition unit 205 acquires input data of the same type as the learning data used for generating the learned model that is used by the inference unit 206.

The inference unit 206 infers the cause of a machining defect obtained using the learned model stored in the learned model storage unit 203. That is, the inference unit 206 can infer to which cluster the feature belongs by inputting at least one feature acquired by the data acquisition unit 205 to the learned model, and can output the inference result as the cause of the machining defect.

In the description of the present embodiment, the cause of the machining defect is output using the learned model learned by the model generation unit 202 of the machining defect analysis device 1B. However, a learned model generated by a learning device other than the machining defect analysis device 1B may be acquired, and the cause of the machining defect may be output based on the learned model.

In this manner, the inference unit 206 can obtain the cause of the machining defect obtained based on at least one feature.

The machining defect analysis unit 110B including this inference device 204 can identify the cause of a machining defect using the function of the inference device 204. For example, the machining defect region extraction unit 114B of the machining defect analysis unit 110B can extract a machining defect region using the same method as in the first embodiment, and the machining defect cause determination unit 115B can determine the cause of the machining defect at the cutting point CP included in the extracted machining defect region using the function of the inference device 204. At this time, the machining defect cause determination unit 115B can use the cause of the machining defect set in the cluster in which a plurality of cutting points CP included in the extracted machining defect region are classified most as the cause of the machining defect in the machining defect region. In addition, the machining defect cause determination unit 115B may extract a plurality of candidates for the cause of machining defect based on the number of cutting points CP in the machining area classified into each cluster, and obtain the determination probability for each cause.

In addition, the machining defect analysis unit 110B may classify all the cutting points CP into clusters of causes of machining defect by using the function of the inference device 204 in the machining defect cause determination unit 115B, and the machining defect region extraction unit 114B may regard a region including a plurality of adjacent cutting points CP classified into the same cluster as one machining defect region based on the classified clusters. In this case, the clusters classified by the inference device 204 also include clusters without machining defects.

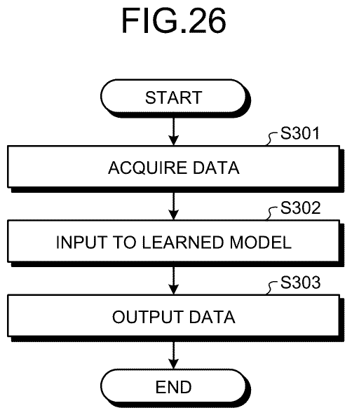

Next, processing for the inference device 204 illustrated in FIG. 25 to obtain the cause of a machining defect will be described with reference to FIG. 26. FIG. 26 is a flowchart for explaining the operation of the inference device 204 illustrated in FIG. 25. The data acquisition unit 205 performs a data acquisition process of acquiring at least one feature from the feature acquisition unit 20 (step S301).

The inference unit 206 inputs at least one feature to the learned model stored in the learned model storage unit 203 and obtains the cause of the machining defect (step S302). The inference unit 206 performs a data output process of outputting the cause of the machining defect obtained by the learned model to the display unit 111 and the like (step S303).

Note that although the case where unsupervised learning is applied to the learning algorithm used by the model generation unit 202 and the inference unit 206 has been described here, the present disclosure is not limited thereto. As the learning algorithm, reinforcement learning, supervised learning, semi-supervised learning, or the like can be applied instead of unsupervised learning.

As a learning algorithm for use in the model construction unit 116, it is also possible to use deep learning, which learns feature extraction directly, or any other known method.

The unsupervised learning in the present embodiment may be implemented by not only non-hierarchical clustering that is based on the k-means described above, but also any other known method that allows for clustering. For example, hierarchical clustering such as nearest neighbor may be used.

In the present embodiment, the functions of the model construction unit 116 and the inference unit 206 may be implemented by a device separate from the machining defect analysis device 1B and connected to the machining defect analysis device 1B via a network, for example. In addition, the functions of the model construction unit 116 and the inference unit 206 may be implemented on a cloud server.

In addition, the model generation unit 202 may learn the cause of a machining defect according to the learning data created for a plurality of machine tools. Note that the model generation unit 202 may acquire learning data from a plurality of machine tools used in the same area, or may learn the cause of a machining defect using learning data collected from a plurality of machine tools operating independently in different areas. In addition, in the middle of learning, it is possible to add a new machine tool to start collecting learning data from the new machine tool, or stop collecting learning data from some machine tool which has been used. Furthermore, a learning device that has learned the cause of a machining defect for a certain machine tool may be applied to the machining defect analysis of a different machine tool, and the cause of the machining defect may be relearned and updated for the different machine tool.

Note that the functions of the machining defect analysis device 1B according to the second embodiment can also be implemented using the computer system illustrated in FIG. 20 as in the first embodiment. Similarly to the first embodiment, each of the function of generating cutting point information and the function of calculating a feature may be implemented by a device different from the machining defect analysis unit 110B. Some of the functions of the machining defect analysis device 1B may be implemented using a cloud system.

As described above, the machining defect analysis device 1B according to the second embodiment includes the learning data acquisition unit 201 that acquires learning data, and the model generation unit 202 that generates a learned model for inferring the cause of a machining defect from at least one feature using the learning data. Therefore, it is possible to generate a learned model for estimating the cause of a machining defect using data of past machining or simulation.

In addition, the machining defect analysis unit 110B can identify the cause of a machining defect by using the learned model. Further, the machining defect analysis unit 110B can classify the cutting points CP into causes of machining defect using the learned model, and can regard a plurality of adjacent cutting points CP classified into the same cause as one machining defect region. With the machining defect analysis device 1B having such a configuration, the cause of the machining defect can be identified using the results of past machining or simulation, and the cause of the machining defect can be more accurately determined. In addition, by acquiring learning data for each user or acquiring learning data that is based on the results of machining or simulation of the machining target shape M1 similar to the machining target shape M1 used by the user, it is possible to determine the cause of the machining defect suitably for the user.

### Third Embodiment

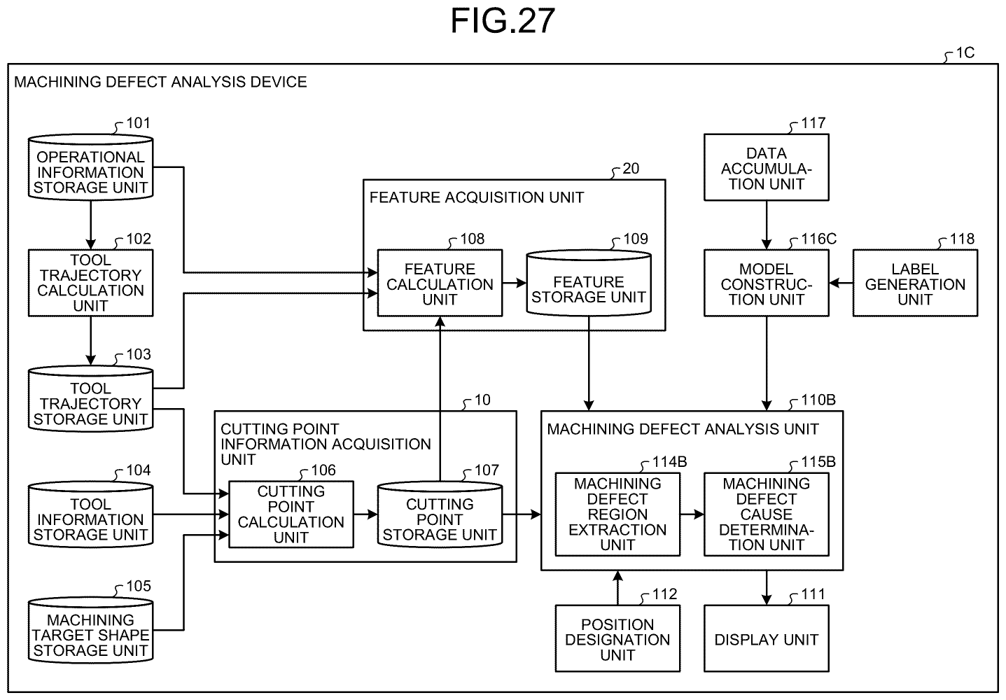

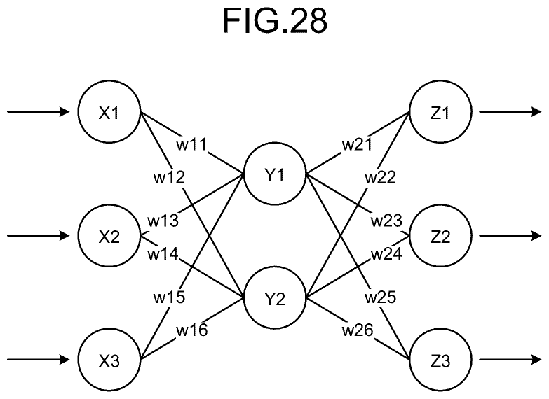

FIG. 27 is a diagram illustrating a functional configuration of a machining defect analysis device 1C according to the third embodiment. The machining defect analysis device 1C includes the operational information storage unit 101, the tool trajectory calculation unit 102, the tool trajectory storage unit 103, the tool information storage unit 104, the machining target shape storage unit 105, the cutting point information acquisition unit 10 including the cutting point calculation unit 106 and the cutting point storage unit 107, the feature acquisition unit 20 including the feature calculation unit 108 and the feature storage unit 109, the machining defect analysis unit 110B including the machining defect region extraction unit 114B and the machining defect cause determination unit 115B, the display unit 111, the position designation unit 112, a model construction unit 116C, the data accumulation unit 117, and a label generation unit 118.

Hereinafter, the description of parts similar to those of the machining defect analysis device 1B according to the second embodiment will be omitted, and differences from the machining defect analysis device 1B will be mainly described.

The label generation unit 118 generates a label to be used when the model construction unit 116C constructs the learned model. The label indicates the cause of a machining defect, and is generated based on input information from the worker. The label generation unit 118 generates a label to be given to the cause of a machining defect based on input information input by the worker using a keyboard, a button, a touch sensor, or the like. For example, the worker designates a region that has a machining defect with respect to the machining target shape M1 of the workpiece W displayed on the display screen, and inputs the cause of the machining defect in the region. The cause of the machining defect to be input may be selected from among those prepared in advance, or the worker may input characters using a keyboard or the like. The label generation unit 118 may acquire input information of the cause of the machining defect input for each cutting point in a tabular form.

The label generation unit 118 generates a label based on input information from the worker. For example, the label generation unit 118 assigns numerical values corresponding to the set causes of machining defect to all the cutting points CP included in the region designated by the worker. At this time, the label generation unit 118 assigns the same numerical value to the same cause of machining defect. Furthermore, the label generation unit 118 may also assign a numerical value indicating that there is no machining defect to the cutting point CP that is not included in the region designated by the worker. The cause of the machining defect determined by the worker can be learned by using the input information from the worker.

The model construction unit 116C generates a learned model having at least one feature as an input and a label generated by the label generation unit 118 as an output.

A detailed functional configuration of the model construction unit 116C will be described with reference to FIG. 23 as in the second embodiment. The model construction unit 116C includes the learning data acquisition unit 201, the model generation unit 202, and the learned model storage unit 203.

The learning data acquisition unit 201 acquires at least one feature and a label generated by the label generation unit 118 as learning data.

The model generation unit 202 learns a label indicating the cause of a machining defect based on learning data generated based on a combination of at least one feature and a label output from the learning data acquisition unit 201. That is, the model generation unit 202 generates a learned model for estimating a label indicating the cause of a machining defect from the feature generated based on the operational information of the machine tool and the tool trajectory. Here, the learning data is data in which at least one feature and a label are associated with each other.

As a learning algorithm that is used by the model generation unit 202, a known algorithm such as supervised learning or reinforcement learning can be used. As an example, a case where a neural network is applied will be described.

The model generation unit 202 learns a label indicating the cause of a machining defect through what is called supervised learning in accordance with a neural network model, for example. Here, supervised learning refers to a method of providing pairs of inputs and results to the learning device to learn features in those learning data and infer results from inputs.

The neural network includes an input layer consisting of a plurality of neurons, an intermediate layer consisting of a plurality of neurons, and an output layer consisting of a plurality of neurons. The number of intermediate layers, which are also called hidden layers, may be one or may be two or more.

FIG. 28 is a diagram schematically illustrating an example of a neural network used by the model construction unit 116C illustrated in FIG. 27. In the three-layer neural network illustrated in FIG. 28, a plurality of inputs are input to input layers X1 to X3, then the values thereof are multiplied by weights W1 (w11 to w16) and input to intermediate layers Y1 and Y2, and the results thereof are further multiplied by weights W2 (w21 to w26) and output from output layers Z1 to Z3. The output results vary depending on the values of the weights W1 and the weights W2.

In the present embodiment, the neural network learns a label indicating the cause of a machining defect through what is called supervised learning according to learning data created based on combinations of features and labels acquired by the learning data acquisition unit 201.

That is, the neural network learns by adjusting the weights W1 and W2 such that the result output from the output layer in response to the input of a feature to the input layer approaches a label indicating the cause of a machining defect. In the learning, the neural network is estimated using error backpropagation such that the value of the output layer approaches the training data. The configuration of the neural network is not limited to the example illustrated in FIG. 28.

The model generation unit 202 executes learning in the above-described manner to generate a learned model, and outputs the generated learned model.

The learned model storage unit 203 stores the learned model output from the model generation unit 202.

A learning algorithm for use in the model generation unit 202 can be deep learning, which learns feature extraction directly. Alternatively, other known methods such as genetic programming, functional logic programming, and support vector machines, for example, can be used to execute machine learning.

In addition, as another example, the model construction unit 116C may generate image data of each feature, acquire learning data including the feature of the image data such as pixel color information (RGB) of the image data and the label generated by the label generation unit 118, and perform learning using the learning data. The image data may be a black-and-white image. In learning using image data, a convolutional neural network is generally used, and parameter estimation is performed using error propagation. Other known methods may be used for parameter estimation.

Note that the functions of the machining defect analysis device 1C according to the third embodiment can also be implemented using the computer system illustrated in FIG. 20 as in the first embodiment. Similarly to the first embodiment, each of the function of generating cutting point information and the function of calculating a feature may be implemented by a device different from the machining defect analysis unit 110B. Furthermore, as long as the input information by the label generation unit 118 can be transmitted to the model construction unit 116C, the model construction unit 116C and the data accumulation unit 117 may be implemented by a device different from the machining defect analysis device 1C. Some of the functions of the machining defect analysis device 1C may be implemented using a cloud system.

As described above, the machining defect analysis device 1C according to the third embodiment includes, in addition to the functions of the machining defect analysis device 1B according to the second embodiment, the label generation unit 118 that generates a label indicating the cause of a machining defect based on input information from the worker, and the model construction unit 116C that generates a learned model having the label generated by the label generation unit 118 as an output. Therefore, it is possible to construct a learned model for estimating the cause of a machining defect reflecting the determination of the worker. Thus, it is possible to reduce the worker's labor for the analysis work of analyzing the cause of a machining defect.

The configurations described in the above-mentioned embodiments indicate examples. The embodiments can be combined with another well-known technique and with each other, and some of the configurations can be omitted or changed in a range not departing from the gist.

For example, although the machining defect analysis devices 1, 1A to 1C that analyze a machining defect that occurs in machining with a machine tool have been described above, it is also possible to provide a machining system including a machine tool that machines the workpiece W with a tool and the machining defect analysis devices 1, 1A to 1C. It is also possible to provide a machining defect analysis method including a step of acquiring cutting point information, a step of acquiring a feature, and a step of identifying a machining defect region and the cause of the machining defect in the machining defect region. It is also possible to provide a machining method further including a step of machining the workpiece W with a machine tool in addition to each step of the machining defect analysis method. Note that the analysis processing of the machining defect may be executed after the machining of the workpiece W with the machine tool or the execution of the simulation is completed, or may be executed in parallel with the machining of the workpiece W with the machine tool or the execution of the simulation.

In addition, the machining defect analysis devices 1, 1A to 1C may be installed near the machine tool and the numerical control device that controls the machine tool, or may be devices that analyze machining with the machine tool at a place away from the machine tool and the numerical control device. Further, the machining defect analysis devices 1, 1A to 1C may be provided as a function of the numerical control device.

### REFERENCE SIGNS LIST

1, 1A, 1B, 1C machining defect analysis device; 2 Information processing device; 10, 10A cutting point information acquisition unit; 20, 20A feature acquisition unit; 81 control unit; 82 input unit; 83 storage unit; 84 display unit; 85 communication unit; 86 output unit; 87 system bus; 101 operational information storage unit; 102 tool trajectory calculation unit; 103 tool trajectory storage unit; 104 tool information storage unit; 105 machining target shape storage unit; 106 cutting point calculation unit; 107 cutting point storage unit; 108 feature calculation unit; 109 feature storage unit; 110, 110B machining defect analysis unit; 111 display unit; 112 position designation unit; 113 cause pattern storage unit; 114, 114B machining defect region extraction unit; 115, 115B machining defect cause determination unit; 116, 116C model construction unit; 117 data accumulation unit; 118 label generation unit; 201 learning data acquisition unit; 202 model generation unit; 203 learned model storage unit; 204 inference device; 205 data acquisition unit; 206 inference unit; CP, CP1 to CP7 cutting point; CPS1 cutting point group; D8 traveling direction; L1a, L1b, L2a, L2b distance; M1 machining target shape; P, P1 to P12 tip point; PL8 plane; Q1, Q2 machining defect region; R1, R2 intersection point; S, S1 to S3 machining curved surface; T1 tool; T1α offset tool; TP1 tool trajectory; V, V1 to V7 tool direction; W workpiece.

1. A machining defect analysis device comprising:
cutting point information acquisition circuitry to acquire cutting point information indicating a position of a cutting point that is a point at which a tool attached to a machine tool cuts a workpiece, the cutting point corresponding to each of a plurality of tip points included in a tool trajectory that is information indicating a movement path of the tip point of the tool;
feature acquisition circuitry to acquire a feature indicating a characteristic of machining, the feature being calculated corresponding to each of the plurality of tip points; and
machining defect analysis circuitry to identify, based on the cutting point information and the feature, a machining defect region in which a machining defect of the workpiece occurs and a cause of the machining defect in the machining defect region.

2. The machining defect analysis device according to claim 1, further comprising a display to display the machining defect region using an expression method that is different depending on each of the cause.

3. The machining defect analysis device according to claim 2, wherein the display displays the feature that is a reason for the cause identified for the machining defect region.

4. The machining defect analysis device according to claim 2, wherein when there is a plurality of candidates for the cause in one machining defect region, the display displays a determination probability for each of the causes.

5. The machining defect analysis device according to claim 1, further comprising
position designation circuitry to receive a designated position that is a position designated on a machining target shape of the workpiece, wherein
the machining defect analysis circuitry extracts a region including the designated position as the machining defect region.

6. The machining defect analysis device according to claim 1, further comprising
cause pattern storage circuitry to store a cause pattern that is information in which a cause of a machining defect is associated with a pattern of the feature in presence of the cause, wherein
the machining defect analysis circuitry identifies the cause of the machining defect region based on the machining defect region extracted, the feature, and the cause pattern.

7. The machining defect analysis device according to claim 1, wherein
the machining defect analysis circuitry includes:
machining defect region extraction circuitry to extract the machining defect region based on the cutting point information and the feature; and
machining defect cause determination circuitry to identify a cause of a machining defect in the machining defect region based on the feature and the machining defect region extracted.

8. The machining defect analysis device according to claim 1, further comprising:
learning data acquisition circuitry to acquire learning data including at least one feature; and
model generation circuitry to generate, using the learning data, a learned model for inferring the cause from the at least one feature.

9. The machining defect analysis device according to claim 8, further comprising
label generation circuitry to generate a label indicating the cause based on input information for each of the cutting point or the machining defect region, wherein
the model generation circuitry generates the learned model having the at least one feature as an input and the label indicating the cause as an output.

10. The machining defect analysis device according to claim 1, wherein using a learned model for inferring the cause from at least one feature, the machining defect analysis circuitry identifies the cause from the feature.

11. The machining defect analysis device according to claim 10, wherein using the learned model having the at least one feature as an input and a label that is information indicating a predetermined candidate for the cause as an output, the machining defect analysis circuitry identifies the cause from the feature.

12. The machining defect analysis device according to claim 10, wherein the machining defect analysis circuitry classifies the cutting point into the cause using the learned model, and regards a plurality of the cutting points adjacent to each other and classified into a same cause as one machining defect region.

13. The machining defect analysis device according to claim 1, wherein the feature acquisition circuitry acquires the feature that is image data or time-series data.

14. The machining defect analysis device according to claim 1, further comprising
tool trajectory calculation circuitry to generate the tool trajectory from operational information that is information indicating an operational status of the machine tool in which the machine tool is operated, wherein
the cutting point information acquisition circuitry includes cutting point calculation circuitry to generate the cutting point information by calculating a position of the cutting point corresponding to each of the plurality of tip points included in the tool trajectory based on the tool trajectory, tool information that is information defining a shape of the tool, and a machining target shape of the workpiece, and
the feature acquisition circuitry includes a feature calculation circuitry to calculate the feature corresponding to each of the plurality of tip points included in the tool trajectory based on the operational information, the tool trajectory, and the cutting point information.

15. A machining system comprising:
a machine tool to machine a workpiece; and
a machining defect analysis device to analyze a machining defect that occurs in machining with the machine tool, wherein
the machining defect analysis device includes:
cutting point information acquisition circuitry to acquire cutting point information indicating a position of a cutting point that is a point at which a tool attached to the machine tool cuts the workpiece, the cutting point corresponding to each of a plurality of tip points included in a tool trajectory that is information indicating a movement path of the tip point of the tool;
feature acquisition circuitry to acquire a feature indicating a characteristic of machining, the feature being calculated corresponding to each of the plurality of tip points; and
machining defect analysis circuitry to identify, based on the cutting point information and the feature, a machining defect region in which a machining defect of the workpiece occurs and a cause of the machining defect in the machining defect region.

16. A machining defect analysis method comprising:
acquiring cutting point information indicating a position of a cutting point that is a point at which a tool attached to a machine tool cuts a workpiece, the cutting point corresponding to each of a plurality of tip points included in a tool trajectory that is information indicating a movement path of the tip point of the tool;
acquiring a feature indicating a characteristic of machining, the feature being calculated corresponding to each of the plurality of tip points; and
identifying, based on the cutting point information and the feature, a machining defect region in which a machining defect of the workpiece occurs and a cause of the machining defect in the machining defect region.

17. A machining method comprising:
machining a workpiece by a machine tool;
acquiring cutting point information indicating a position of a cutting point that is a point at which a tool attached to the machine tool cuts the workpiece when the machine tool machines the workpiece, the cutting point corresponding to each of a plurality of tip points included in a tool trajectory that is information indicating a movement path of the tip point of the tool;
acquiring a feature indicating a characteristic of machining, the feature being calculated corresponding to each of the plurality of tip points; and
identifying, based on the cutting point information and the feature, a machining defect region in which a machining defect of the workpiece occurs and a cause of the machining defect in the machining defect region.
